(19) United States
(12) Patent Application Publication
(10) Pub. No.: US 2012/0146961 A1
(43) Pub. Date: Jun. 14, 2012

(54) Electronic paper

(75) Inventors: Sang Jin Kim, Gyeonggi-do (KR); Hwan Soo Lee, Seoul (KR); Jung Min Park, Gyeonggi-do (KR); Sang Moon Lee, Seoul (KR)

(73) Assignee: Samsung Electro-Mechanics Co., Ltd., Suwon (KR)

(21) Appl. No.: 13/067,970

(22) Filed: Jul. 12, 2011

(30) Foreign Application Priority Data
Dec. 9, 2010 (KR) 10-2010-0125281

(51) Int. Cl. G09G 5/00

(52) U.S. Cl. 345/204

(57) ABSTRACT

Disclosed herein is an electronic paper, more particularly to an electronic paper capable of actually realizing full colors. The electronic paper includes upper and lower electrodes made of a transparent material and disposed to face each other; transparent barrier ribs disposed between the upper and lower electrodes to form a plurality of cells; twist balls each having a sphere-shaped structure and received in each of the cells, the twist ball having first and second display regions on a surface thereof and the first and second display regions being colored with different colors and respectively electrified with positive charges and negative charges; and a black matrix layer provided below the transparent barrier ribs, the black matrix layer having a larger width than the transparent barrier rib.

### CROSS REFERENCE(S) TO RELATED APPLICATIONS

This application claims the benefit under 35 U.S.C. Section 119 of Korean Patent Application Serial No. 10-2010-0125281, entitled “Electronic Paper” filed on Dec. 9, 2010, which is hereby incorporated by reference in its entirety into this application.

### BACKGROUND OF THE INVENTION

1. Technical Field

The present invention relates to an electronic paper, and more particularly to an electronic paper capable of actually realizing full colors.

2. Description of the Related Art

An electronic paper, by definition, is thin and flexible, like paper, but a device, which is not printed by ink, capable of performing a displaying operation by using electric signals. An electronic paper, which looks like a plastic sheet, enables a user to carry in a bent state or rolled state and read electronic document anywhere. This could be a high-technology product, which is a great forward of a printing technique in which the existing paper is used as a medium.

This electronic paper is expected to substitute for general paper in the near future. The electronic paper has the same operational principle as an LCD, fundamentally. However, the LCD is bright due to light emitted from the rear while the electronic paper is slightly dark because reflected light is seen.

The electronic paper has an advantage in that a picture can be maintained as it is even when the power supply is cut off, but a picture on the LCD is instantly disappeared when the power supply is cut off. In other words, the electronic paper allows an electronic book to be visible even with a far smaller amount of electricity than a notebook computer, since the picture is maintained as it self even though the power supply is cut off and only the changing of the picture consumes electricity. In addition, since the electronic paper employs a reflection mode in which outside light is used, information on the electronic paper can be viewed under bright sunlight. However, information on the LCD is difficult to view under bright sunlight. Besides, the electronic paper has the same recognizability as paper, and as a result, prevents eyes of a user from being strained, while when the LCD is used for one hour or longer, the eyes of the user becomes strained.

Due to these advantages, the electronic paper may be variously applied to a wide range of applications, such as an electronic book having a paper-like surface and moving illustrations, a renewable newspaper, a reusable paper display for a mobile phone, a disposable TV screen, electronic wallpaper, or the like, and has a huge potential market.

Technical approaches for embodying this electronic paper are largely a method of using liquid crystal, a method of using organic EL, an electrophoresis method, a method of using a dichroic rotatable particle (e.g., a twist ball), an electrochromic method, and the like. Among them, the method of using the twist ball generally has a configuration in which a plurality of twist balls each having a hemisphere exhibiting black and a hemisphere exhibiting white, are disposed between two parallel trans-missive sheets (hereinafter, referred to as an elastomer matrix made of a material such as elastomer.

The twist ball has optical and electrical anisotropies. In other words, a white hemisphere portion is negatively electrified and a black hemisphere portion is positively electrified, and thereby, a permanent dipole is formed. The twist ball is coated with liquid to be rotatable in an elastomer matrix. In other words, the electronic paper using twist balls is capable of displaying a desired image by applying an electric field to the elastomer matrix to rotate the twist balls selectively.

FIG. 1 is a view showing an electronic paper using twist balls according to the related art. As shown in FIG. 1, an electronic paper according to the related art includes upper and lower electrodes 14 and 13 made of transparent materials and disposed to face each other, and twist balls 1 disposed between the upper and lower electrodes 14 and 13. Each of the twist balls 1 has first and second display regions 11 and 12 formed on a surface thereof. The first and second display regions 11 and 12 are respectively colored with different colors and electrified with different types of charges. The electronic paper may further include a barrier rib structure 15 disposed between the upper and lower electrodes 14 and 13 to receive the twist balls 1. An electric insulation type transparent medium 16 sealing the twist balls 1 may be further included inside cells A formed in a barrier rib structure 15.

In recent years, hemispheres of these twist balls are colored with various colors such as red, green, blue, and the like, and thereby to realize full colors. However, in a case in which respective twist balls are put in the cells A surrounded by the barrier rib structure 15, an electronic paper exhibiting white and black colors can be favorably operated, but, in an electronic paper exhibiting colors, twist balls exhibiting red, green, blue, and the like have to exhibit accurate colors in respective cells to enable desired colors to be entirely exhibited, resulting in difficulty in exhibiting full colors.

That is to say, when a plurality of cells in which twist balls exhibiting red, green, blue, and the like are inserted are gathered to form one pixel, and colors of respective cells in the pixel are combined to exhibit various colors, accurate color exhibition can not be realized in respective cells. The reason is that the barrier rib structure 15 surrounding respective cells is generally formed of an opaque polymer film material such as GX13 by a lamination method, and here, the color of the barrier rib structure 15 is changed to a pale-orange color but not white, due to the thermosetting temperature. In this case, the barrier rib structure is favorably usable in a black and white operation mode. However, the colors exhibited from the respective cells are affected by the color of the barrier rib structure 15, thereby preventing accurate colors from being exhibited in a full-color operation mode. As a result, the colors emitted from the pixel through color mixing are deteriorated in brightness and chroma.

Consequently, the electronic paper according to the related art has a defect in which full colors are not actually realized.

### SUMMARY OF THE INVENTION

An object of the present invention is to provide an electronic paper capable of allowing chroma and brightness of colors reflected from respective cells to be accurate by forming a barrier rib structure of a transparent material, and thereby to realize full colors.

Another object of the present invention is to provide an electronic paper in which problems caused by a transparent barrier rib structure is solved by using a black matrix layer to actually realize full colors.

According to an exemplary embodiment of the present invention, there is provided an electronic paper, including: upper and lower electrodes made of a transparent material and disposed to face each other; transparent barrier ribs disposed between the upper and lower electrodes to form a plurality of cells; twist balls each having a sphere-shaped structure and received in each of the cells, the twist ball having first and second display regions on a surface thereof and the first and second display regions being colored with different colors and respectively electrified with positive charges and negative charges; and a black matrix layer provided below the transparent barrier ribs, the black matrix layer having a larger width than the transparent barrier rib.

The black matrix layer may be provided on an upper surface or a lower surface of the lower electrode.

The electronic paper may further include a white dielectric material coated on the upper surface or the lower surface of the lower electrode correspondingly to a portion in which the black matrix layer is not provided.

The white dielectric material may be coated more widely than the diameter of the twist ball.

The black matrix layer may have a width varying according to the colors with which the twist balls received in the neighboring cells are colored.

An electrical insulation type transparent medium sealing the twist ball may be further included inside the cell.

The first and second display regions may be formed at regions corresponding to hemispheres of the structure, respectively.

### BRIEF DESCRIPTION OF THE DRAWINGS

FIG. 1 is a cross-sectional view showing a structure of an electronic paper according to the related art;

FIG. 2 is a cross-sectional view showing an electronic paper according to an exemplary embodiment of the present invention;

FIG. 3 is a reference view for explaining a mechanism in which problems of the related art are solved by an electronic paper according to the present invention;

FIG. 4 is an upper plane view of a lower substrate in which transparent barrier ribs are formed in the present invention; and

FIG. 5 is an upper plane view of a lower substrate in which twist balls are disposed in the present invention.

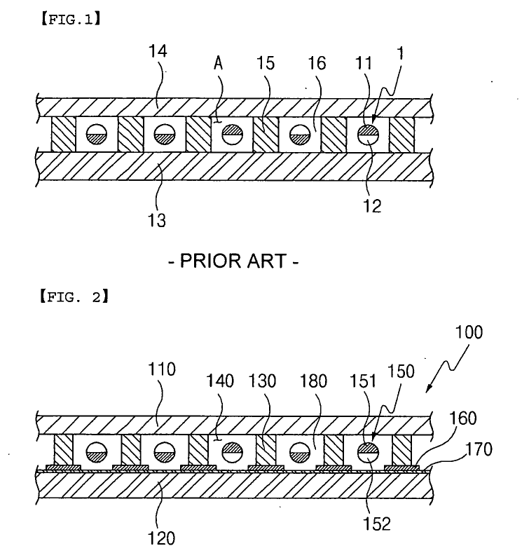

### DESCRIPTION OF THE PREFERRED EMBODIMENTS

Hereinafter, exemplary embodiments of the present invention will be described in detail with reference to the accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

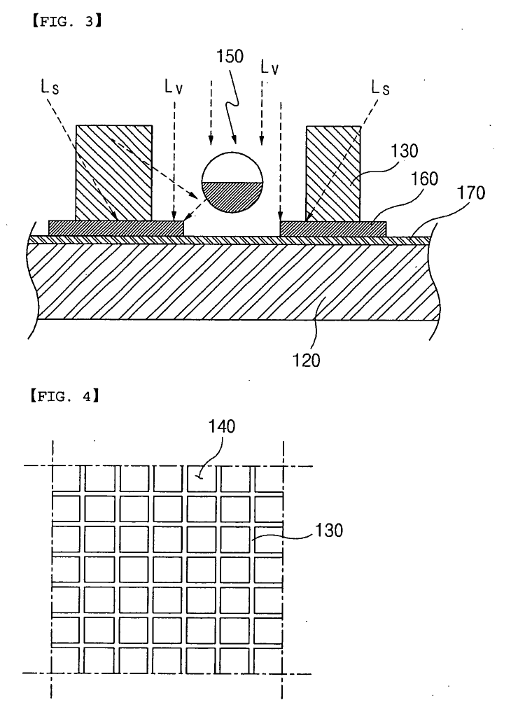

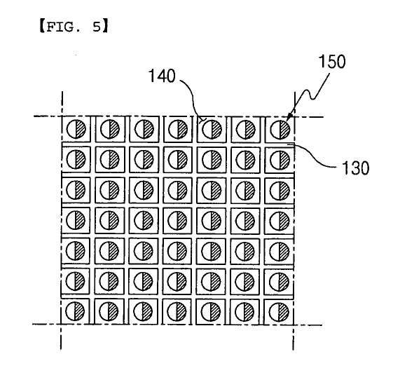

FIG. 2 is a cross-sectional view showing an electronic paper according to an exemplary embodiment of the present invention. Referring to FIG. 2, an electronic paper 100 according to an exemplary embodiment of the present invention includes an upper electrode 110 and a lower electrode 120 made of transparent materials and disposed to face each other, transparent barrier ribs 130 disposed between the upper electrode 110 and lower electrodes 120 to form a plurality of cells 140, twist balls each received in each of the cells 140 and having a sphere-shaped structure, the twist ball 150 having a surface colored with different colors and including a first display region 151 and a second display region 152 electrified with positive charges and negative charges, respectively, and a black matrix layer 160 provided below the transparent barrier ribs 130 to have a larger width than the transparent barrier ribs 130. Also, within the cell, in a portion in which the black matrix layer is not provided, preferably, a white dielectric material is coated on an upper surface or a lower surface of the lower electrode 120.

More specially, the lower electrode 120 and the upper electrode 110 are preferably made of flexible materials such as glass or flexible plastic. Here, the thickness of the lower electrode 120, which constitutes a bottom surface of the cell 140, needs to be regulated to the extent that a magnetic field is generated on the twist ball 150 in each cell 140. The lower electrode 120 further includes an electrode (not shown) patterned correspondingly to each cell 140. In the same manner, the thickness of the upper electrode 110 needs to be regulated to the extent that a magnetic field is generated on the twist ball 150 in each cell 140.

Alternatively, the upper and lower electrodes 110 and 120 are made of a transparent and conductive material, e.g., a material such as ITO, and function as a member for applying a voltage to the twist ball 150. In this case, although not shown separately, a regulating member for regulating the level and direction of voltage applied to the respective twist balls 150 may be provided.

The transparent barrier ribs 130 are disposed between the upper and lower electrodes 110 and 120 to separately receive the twist balls 150 by the cell unit 140. In order to achieve structural stability, the height of the transparent barrier rib 130 is preferably larger than the diameter of the twist ball 150.

An electric insulation type transparent medium 180 is provided between the transparent barrier ribs 130 to seal the twist ball 150 so that the twist ball 150 can be easily rotated, and may be made of an appropriate transparent organic material having a small rotational resistance.

A sphere-shaped structure constituting the twist ball 150, of which an inside is generally filled, may be manufactured by using zirconia. On the other hand, the specific gravity of the twist ball 150 can be significantly lowered by providing the twist ball 150 having an empty inside and forming the inside thereof in a state of vacuum or air void. In this case, an organic material or an inorganic material may be used, and the organic material is properly selected from, e.g., PMMA, silicon resin, urethane resin, or the like, and the inorganic material is properly selected from, e.g., silica, alumina, glass, or the like.

As shown in FIG. 2, the twist ball 150 according to an exemplary embodiment of the present invention is a sphere-shaped structure, and the first and second display regions 151 and 152 are formed on a surface thereof. The first and second display regions 151 and 152 are colored with different colors, such that the twist ball 150, when seen from a specific position, exhibits different colors as it rotates. For example, the first and second display regions 151 and 152 may be respectively colored with black and white. In the present exemplary embodiment, a case in which two display regions corresponding to semisphere regions of the above structure are formed on the surface of the twist ball 150 is taken as an example, but, as necessary, the number of display regions may be 3 or more. The display regions may be colored with various colors but not black or white, and thereby to realize full colors.

In order to enable the twist ball 150 to be rotated by application of voltage, the first and second display regions 151 and 152 are electrified to have different polarities, and for example, they are respectively electrified with positive charges and negative charges. In this case, a method known to the art may be used in treating the surface of the sphere-shaped structure electrically and optically, to form the first and second display regions 151 and 152. For example, a method in which the sphere-shaped structure having the empty inside is inputted in a rotational disc having two kinds of coloring liquid, and then a centrifugal force is applied, may be used.

In addition, the black matrix layer 160 layer having a larger width than the transparent barrier rib 130 is provided below the transparent barrier ribs 130. The black matrix layer 160 provided on an upper surface of the lower electrode 120 is shown in FIG. 2, but the black matrix layer 160 may be provided on a lower surface of the lower electrode 120.

The black matrix layer 160 is formed of a mixture of at least one of an insulating material, an organic material, an inorganic material, and a polymeric material, and a black material, e.g., black carbon or the like. Also, the black matrix layer 160 may be formed of a mixture in which photoresist, which is a general insulating material, and red (R), green (G), and blue (B) dyes are mixed.

Also, as for the cell, in a portion in which the black matrix layer 160 is not provided, the white dielectric material 170 is coated on the upper surface or the lower surface of the lower electrode 120. When the black matrix layer 160 is coated, color reproduction becomes better but brightness characteristic is not good. Accordingly, a white dielectric material having a superior reflecting characteristic is coated to compensate for this defect. In addition, the widths of the coated white dielectric material 170 and black matrix layer 160 are flexibly regulated according to the colors with which the twist balls of the neighboring cells are colored.

As shown in FIG. 2, the white dielectric material 170 is provided below the black matrix layer 160 while being entirely coated on the upper surface of the lower electrode 120, but not limited thereto. In other words, any type in which the white dielectric material 170 is provided at a portion in which the black matrix layer 160 is not formed is preferable in the present invention. That is to say, any portion in which the black matrix layer 160 is not provided on the bottom of the cell 140 is preferable even though the black matrix layer 160 is provided at the same plane as the black matrix layer 160. Moreover, the type in which the white dielectric material 170 is provided on the lower surface of the lower electrode 120 is preferable. In this case, the type in which the white dielectric material 170 are formed on the entire surface of the lower electrode 120, or selectively provided at a portion in which the black matrix layer 160 is not provided and which is positioned in vertical upward, is preferable.

Here, the white dielectric material 170 is preferably coated more widely than the diameter of the twist ball 150, so that, some of the vertically incident light Lv incident from the left, right, front, and rear of the twist ball 150 inside the cell 140 can be efficiently reflected. Since, when the reflectance of white paper is generally regarded as 100%, the reflectance at the cell 140 needs to be 30% or more, which enables given colors to be accurately exhibited by respective cells 140, a reduction in the amount of reflected light due to shielding of the black matrix layer 160 is supplemented by the white dielectric material 170. Preferably, the width of the black matrix layer 160 varies according to the colors of the twist ball 150 received in the neighboring cell 140. The brightness depends on the color with which the twist ball 150 is colored, and thus, needs to be adjusted. For example, since BLUE is lower than RED, or GREEN in brightness, the black matrix layer 160 is made to have a smaller width when neighboring the cell 140 in which a BLUE-colored twist ball 150 is provided than when neighboring the cell 140 in which a RED-, or GREEN-colored twist ball 150 is provided, thereby adjusting the brightness equally.

Hereinafter, a mechanism in which problems of the related art are solved by an electronic paper according to the present invention will be described with reference to FIG. 3.

In the related art, the barrier ribs are mostly formed of a polymer film material such as a product name, GX13, of Ajinomoto Co., Ltd, Japan, by a lamination method. Here, the color of the barrier rib is changed to opaque pale-orange color but not white, due to the thermosetting temperature. In this case, the barrier rib structure is favorably usable in a black and white operation mode. However, the colors exhibited by the respective cells are affected by the color of the barrier rib structure, thereby preventing accurate colors from being exhibited in a full-color operation mode. As a result, the colors emitted from the pixel by color mixing are deteriorated in brightness and chroma.

Accordingly, in the present invention, as shown in FIG. 3, the accurate color can be reflected by providing the transparent barrier rib 130, which prevents the light from being affected by the barrier ribs. However, vertically incident light Lv as well as a side incident light Ls passing through the transparent barrier rib 130 is incident when the transparent barrier rib 130 is used. When the side incident light Ls is incident, the desired light reflectance is not obtained, and thus, the desired color for each cell cannot be realized.

In order to solve the problem of the side incident light Ls, the present invention includes the black matrix layer 160 having a larger width than the transparent barrier rib 130 below the transparent barrier ribs 130. The black matrix layer 160 absorbs the side incident light Ls directly, or absorbs the side incident light Ls reflected from the twist ball 150. The side incident light Ls is almost absorbed into the black matrix layer 160 in this manner. Moreover, the black matrix layer 160 absorbs some of the vertically incident light Lv, for example, some of the light reflected without passing through the twist ball 150, thereby preventing colors such as R, G, B, and the like, which are reflected from the respective cells, from being distorted.

However, since color reproduction becomes better but brightness characteristic is not good in a case where the black matrix layer 160 is provided, a white dielectric material having a superior reflecting characteristic is preferably coated to compensate this defect.

Furthermore, the black matrix layer 160 is preferably made to have a width varying according to the colors of the twist ball 150 received in the neighboring cell 140. The brightness depends on the color with which the twist ball 150 is colored, and thus, needs to be adjusted. For example, since BLUE is lower than RED, or GREEN in brightness, the black matrix layer 160 is made to have a smaller width when neighboring the cell 140 in which a BLUE-colored twist ball 150 is provided than when neighboring the cell 140 in which a RED-, or GREEN-colored twist ball 150 is provided, thereby adjusting the brightness equally. When determined approximately, in a case where twist balls 150 colored with RED or GREEN is provided, the white dielectric material 170 is preferably coated on 50 to 70% of the total area in the bottom of each cell 140, and in a case where twist balls 150 colored with BLUE is provided, the white dielectric material 170 is preferably coated on 60 to 75% of the total area in the bottom of each cell 140.

As set forth above, according to the present invention, there can be provided an electronic paper capable of allowing chroma and brightness of colors reflected from respective cells to be accurate, by forming a barrier rib structure of a transparent material, thereby realizing full colors.

In addition, according to the present invention, there can be provided an electronic paper in which problems caused by a transparent barrier rib structure is solved by using a black matrix layer to actually realize full colors.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An electronic paper, comprising:
upper and lower electrodes made of a transparent material and disposed to face each other;
transparent barrier ribs disposed between the upper and lower electrodes to form a plurality of cells;
twist balls each having a sphere-shaped structure and received in each of the cells, the twist ball having first and second display regions on a surface thereof and the first and second display regions being colored with different colors and respectively electrified with positive charges and negative charges; and
a black matrix layer provided below the transparent barrier ribs, the black matrix layer having a larger width than the transparent barrier rib.

2. The electronic paper according to claim 1, wherein the black matrix layer is provided on an upper surface or a lower surface of the lower electrode.

3. The electronic paper according to claim 2, further comprising a white dielectric material coated on the upper surface or the lower surface of the lower electrode correspondingly to a portion in which the black matrix layer is not provided.

4. The electronic paper according to claim 3, wherein the white dielectric material is coated more widely than the diameter of the twist ball.

5. The electronic paper according to claim 1, wherein the black matrix layer has a width varying according to the colors with which the twist balls received in the neighboring cells are colored.

6. The electronic paper according to claim 1, wherein an electrical insulation type transparent medium sealing the twist ball is further included inside the cell.

7. The electronic paper according to claim 1, wherein the first and second display regions are formed at regions corresponding to hemispheres of the structure, respectively.
